(19) United States
(12) Patent Application Publication
(10) Pub. No.: US 2024/0030493 A1
(43) Pub. Date: Jan. 25, 2024

(54) Electrolytes Having Nonfluorinated Hybrid-Ether Cosolvent Systems, Methods of Making Such Electrolytes, and Electrochemical Devices Utilizing Such Electrolytes

(71) Applicant: SES Holdings Pte. Ltd., Gingapore (SG)

(72) Inventors: Bin Liu, Lexington, MA (US); Qichao Hu, Arlington, MA (US)

(21) Appl. No.: 18/265,948

(22) PCT Filed: Nov. 17, 2021
(86) PCT No.: PCT/IB2021/060672

§ 371 Date: Jun. 7, 2023

Related U.S. Application Data
(60) Provisional application No. 63/125,164, filed on Dec. 14, 2020.

(51) Int. Cl. H01M 10/0569; H01G 11/60; H01G 11/62

(52) U.S. Cl. CPC H01M 10/0569; H01G 11/60; H01G 11/62; H01M 2300/0037

(57) ABSTRACT

In some embodiments, hybrid-ether electrolytes that include a nonfluorinated hybrid-ether cosolvent system having at least one nonfluorinated cyclic ether and at least one nonfluorinated linear ether, wherein the number of cations, M, of an active metal (having a solvation number, SN) within the hybrid-ether electrolyte are provided in an amount such that a molar ratio between M and the number of oxygen atoms in the nonfluorinated hybrid-ether cosolvent system falls within a desired range. In some embodiments, a hybrid-ether electrolyte of this disclosure further includes at least one fluorinated ether. In some embodiments, a hybrid-ether electrolyte of this disclosure may optionally include one or more solvents differing from the solvents in the nonfluorinated hybrid-ether cosolvent system and, if provided, different from the fluorinated ether(s). Methods of making a hybrid-ether electrolyte are also disclosed, as are electrochemical cells utilizing hybrid-ether electrolytes made in accordance with the present disclosure.

### RELATED APPLICATION DATA

This application claims the benefit of priority of U.S. Provisional Patent Application Ser. No. 63/125,164, filed Dec. 14, 2020, and titled “Lithium Cation-Ether Oxygen Coordinated Hybrid Ether Electrolytes Enabling High Performance Lithium Batteries”, which is incorporated by reference herein in its entirety.

### FIELD OF THE INVENTION

The present invention generally relates to the field of electrolytes for active-metal electrochemical cells. In particular, the present invention is directed to electrolytes having nonfluorinated hybrid-ether cosolvent systems, methods of making such electrolytes, and electrochemical devices utilizing such electrolytes.

### BACKGROUND

State-of-the-art lithium-ion batteries using graphite anodes having a theoretical capacity of ˜372 mAh g⁻¹ have almost reached their theoretical energy density, but they still cannot provide the high energy density needed to meet some application requirements, especially for long-range electric vehicles. Lithium metal has been proverbially considered as an ideal anode candidate, since it has an ultrahigh theoretical capacity (3,860 mAh g⁻¹) and very low redox potential (−3.040 V versus standard hydrogen electrode). Over the four decades of research on lithium-metal anodes, scientists have made numerous efforts to push the limits of lithium-metal battery development. However, several remaining hurdles need to be surmounted prior to achieving practical implementation of lithium-metal anodes in rechargeable (i.e., secondary) lithium-metal batteries. These include: (1) uncontrollable lithium dendrite growth results in severe safety issues; (2) the thermodynamic instability of lithium metal can cause irreversible and continuous reactions between the lithium and electrolyte that consume both lithium and electrolyte quickly and increase internal resistance; and (3) large volumetric and morphological changes happen in the lithium metal anode during plating/stripping of charging/discharging, but the solid electrolyte interphase (SEI) films are too frail to fully suppress such significant changes in the lithium-metal electrode.

### SUMMARY OF THE DISCLOSURE

In an implementation, the present disclosure is directed to a hybrid-ether electrolyte, which includes at least one salt comprising a total number of cations, M, of an active metal, wherein the active metal has a solvation number, SN; and a nonfluorinated hybrid-ether cosolvent system that consists of at least one nonfluorinated cyclic ether and at least one nonfluorinated linear ether, wherein the nonfluorinated hybrid-ether cosolvent system has a total number of oxygen atoms, O; and wherein the at least one salt and the nonfluorinated hybrid-ether cosolvent system are present in respective amounts such that the hybrid-ether electrolyte has an M:O molar ratio in a range of about 1:(SN−3) to about 1:(SN+3).

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a graph of capacity retention versus cycle number for a first set of 3/4-layer pouch cells containing corresponding ones of the electrolytes listed in Table 1 and cycled using a 0.2C charge rate and a 0.1C discharge rate;

FIG. 2 is a graph of capacity retention versus cycle number for a second set of 3/4-layer pouch cells containing corresponding ones of the electrolytes listed in Table 1 and cycled using a 0.33C charge rate and a 0.33C discharge rate;

FIG. 3 is a graph of capacity retention versus cycle number for a third set of 3/4-layer pouch cells containing corresponding ones of the electrolytes listed in Table 1 and cycled using a 0.2C charge rate and a 1.0C discharge rate;

FIG. 4A is a chart of amount of gas generation for two 10/11-layer pouch cells, one each containing the control and the hybrid ether 3 electrolytes of Table 1;

FIG. 4B is a chart of recovered capacity ratio for the two pouch cells of FIG. 4A;

FIG. 5 is a graph of capacity retention versus cycle number for a first pair of 3/4-layer pouch cells, one each containing the control and the hybrid ether 3 electrolytes of Table 1, cycled using a 0.33C charge rate and a 0.33C discharge rate;

FIG. 6 is a graph of capacity retention versus cycle number for a second pair of 3/4-layer pouch cells, one each containing the control and the hybrid ether 3 electrolytes of Table 1, cycled using a 0.2C charge rate and a 0.1C discharge rate;

FIG. 7 is a graph of capacity retention versus cycle number for a third pair of 3/4-layer pouch cells, one each containing the control and the hybrid ether 3 electrolytes of Table 1, cycled using a 0.33C charge rate and a 0.33C discharge rate;

FIG. 8 is a graph of capacity retention versus cycle number for a second pair of 3/4-layer pouch cells, one each containing the control and the hybrid ether 3 electrolytes of Table 1, cycled using a 0.2C charge rate and a 0.1C discharge rate; and

FIG. 9 is a diagram of an electrochemical cell of the present disclosure containing a hybrid-ether electrolyte as described herein.

### DETAILED DESCRIPTION

General

In some aspects, the present disclosure is directed to hybrid-ether electrolytes, or sometimes simply “electrolytes”, for electrochemical devices such as batteries and supercapacitors, including, but not limited to, electrochemical devices based on lithium as the active metal, such as lithium-metal and lithium-ion secondary batteries. In some embodiments, the electrolyte includes at least one nonfluorinated cyclic ether, at least one nonfluorinated linear ether (can also include branched linear ether and branched cyclic ether, though “linear ether” is used for simplicity), and at least one salt, in which the molar ratio of salt cations to oxygen atoms in the combination of the nonfluorinated cyclic and linear ethers, or the molar ratio of salt cations to solvent molecules in the nonfluorinated cyclic+linear ether combination, is tailored to minimize the amount of free solvent, i.e., the amount of nonfluorinated solvents in the cyclic+linear ether combination not coordinated with any salt cations, in the electrolyte. As used herein and in the appended claims, the term “nonfluorinated hybrid-ether cosolvent system” is used to describe a solvent system containing at least one nonfluorinated cyclic ether and at least one nonfluorinated linear ether, with the word “hybrid” indicating the presence of both cyclic and linear ethers.

In some embodiments, electrolytes of the present disclosure are formulated to address a major bottleneck of conventional electrolytes for lithium-metal secondary batteries described in the Background section above, namely poor cycling stability, which is attributed to low coulombic efficiency (CE) of the lithium-metal anodes in most conventional electrolytes during cycling. These formulations provide a new class of “hybrid-ether electrolytes” having extremely high stability towards lithium-metal anodes and high antioxidation characteristics to significantly improve cycling performance of rechargeable lithium-metal batteries, which greatly advances the boundaries of applications of high-energy lithium batteries.

More particularly, new hybrid-ether electrolytes of the present disclosure are able to decrease side reactions with the active metal (e.g., lithium), significantly increase CE of lithium plating/stripping, and suppress or mitigate lithium dendrite growth. These effects result in significant improvements in cycle life. In order to compete with >400 wh/kg lithium-metal batteries containing traditional electrolytes with poor cycle life (within 100 cycles), the cycling stability of the new hybrid-ether electrolytes has been verified in different testing protocols, which has demonstrated much improved battery performance. By carefully combining the above new electrolyte components and designing electrolyte formulations in accordance with principles disclosed herein, active-metal batteries relying on new hybrid-ether electrolytes of the present disclosure can demonstrate long-lasting cycling lives, high energy density, and high safety.

In some embodiments, a hybrid-ether electrolyte of the present disclosure may further include one or more fluorinated ethers to provide one or more functions, such as to function as a diluent solvent to reduce the electrolyte salt concentration, reduce viscosity of the electrolyte, improve oxidative stability of the electrolyte against high voltages, and/or contribute to forming a solid electrolyte interphase (SEI) layer on an anode.

In some embodiments, including both electrolytes without and with one or more fluorinated ethers, the corresponding electrolyte may include one or more additives that do not materially affect the tailored balance of the salt cations with the oxygen atoms in the nonfluorinated hybrid-ether cosolvent system. Examples of such additives include, but are not limited to LiDFOB, LiBOB, LiDFP, VC, FEC, PS, PES, DTD, MMDS, TTMSPi, TMSDEA, TEOS, TSA, LiTFPFB, and dialkyl carbonate (alkyl=allyl, benzyl, etc.), among others. In some embodiments, including both electrolytes without and with one or more fluorinated ethers, the corresponding electrolyte may consist only of the nonfluorinated hybrid-ether cosolvent system and one or more salts, without or with one or more fluorinated ethers. In some embodiments, an electrolyte of the present disclosure may be incorporated into a gel electrolyte using any known or otherwise suitable gel-forming process that incorporates a liquid electrolyte made in accordance with the present disclosure.

In some aspects, the present disclosure is directed to electrochemical devices, such as batteries and supercapacitors, that include an electrolyte made in accordance with the present disclosure. Examples of batteries include secondary and primary batteries utilizing any of lithium, sodium, potassium, calcium, and magnesium, among others, as the active metal. These batteries may be of any suitable type, such as a metal-plating/stripping type (e.g., lithium-metal type, etc.) or an ion-intercalation type (e.g., a lithium-ion type, etc.), among others. Fundamentally, the construction and form of an electrochemical device of the present disclosure can be any suitable construction and form, as long as it includes an electrolyte of the present disclosure. Those skilled in the art are familiar with many constructions and forms of electrochemical devices, such that it is not necessary to either provide an exhaustive list or describe any in any significant detail for those skilled in the art to understand that broad scope of the present inventions and disclosure. Each of these and other aspects of the present disclosure are described below.

In a previous discovery in advanced electrolytes, a localized-concentrated high-concentration electrolyte, composed of lithium bis(fluorosulfonyl)imide (LiFSI, Li⁺[(FSO₂)₂N]⁻) as a salt, 1,2-diethoxy ethane (DEE) as a solvent, and 1,2-(1,1,2,2-tetrafluoroethoxy)ethane (TFE) as a cosolvent, allowed secondary lithium-metal batteries to achieve superior cycling performance as compared to conventional electrolytes of that time. However, in light of observed battery performance relying on this linear-ether-based electrolyte, there are still unsatisfied factors and still much more space to further improve both the thermodynamic stability of electrolytes towards a lithium-metal anode and the oxidative stability of electrolytes at high voltage and to decrease the amount of gas generation during high-temperature storage.

The cyclic dioxane (DX) ether 1,4-dioxane (1,4-DX) has been reported as being used with LiFSI salt to create a dilute 1.0 M LiFSI-DX electrolyte for lithium-metal rechargeable (secondary) cells. 1,4-DX has many advantages, such as extremely low reduction potential, resulting in greatly enhanced thermodynamic stability against lithium-metal anodes, improved oxidative stability at high voltage, no gaseous decomposition products, high boiling point, and low cost, among others. Unfortunately, such a dilute LiFSI-DX electrolyte (only 1.0 M) allows most of the molecules of the 1,4-DX solvent to exist freely without any coordination with the LiFSI salt, which inevitably results in unsatisfactory cycling stability in lithium-metal batteries. Although 1,4-DX is more stable toward lithium than corresponding linear ethers, its oxidative stability is low (<4.0 V) when present as free solvent in the dilute electrolyte. Unfortunately, the chemical nature of the DX solvent is such that higher LiFSI salt concentrations in DX cannot be achieved due to the low solubility of the LiFSI salt in the DX solvent.

The present inventors have discovered, however, that it is highly desired in formulating electrolytes for active-metal electrochemical cells, such as lithium-metal cells, to combine one or more nonfluorinated cyclic ethers with one or more nonfluorinated linear ethers to make a nonfluorinated hybrid-ether cosolvent system. Such combination takes advantage of the synergy created by leveraging the higher thermodynamic stability of nonfluorinated cyclic ethers against active-metal (e.g., lithium) anodes in combination with the higher solubilities of the salt(s) of interest in nonfluorinated linear ethers to maximize salt-solvent coordination while at the same time minimizing free solvent molecules in the nonfluorinated hybrid-ether cosolvent system of the electrolyte. As used herein, the term “active metal” and like terms in the context of an electrochemical cell of the present disclosure refers to a metal, ions of which flow within the electrochemical cell between an anode and a cathode of the cell and strip or de-intercalate from the anode during discharging and plate or intercalate to the anode during charging of the electrochemical cell. The term “active-metal anode” refers to an anode of a plating/stripping type that is plated/stripped with/of active-metal cations during charging/discharging, while “active-cation anode” refers to an anode of an intercalation type that is intercalated/de-intercalated with/of active-metal cations during charging/discharging.

As mentioned above, some embodiments of electrolytes disclosed herein can further benefit from the addition of one or more fluorinated ethers (e.g., fluorinated linear ethers) that allow electrolyte chemists, for example, to fine-tune electrolyte concentrations to optimal concentrations with minimal solvation of the salt(s) with the diluent fluorinated ether(s) and/or to provide one or more other functionalities, such as reducing viscosity of the electrolyte, improving oxidative stability of the electrolyte against high voltages, and/or contributing to forming an SEI layer on an anode. Disclosed herein are new discoveries of unexpected results for new electrolyte formulations that overcome poor-cycling-stability issues and allow building of new stable electrochemical-device chemistries.

Detailed examples of hybrid-ether electrolytes are described below using lithium as the active metal. However, those skilled in the art will readily appreciate that the underlying principles of these examples can be extended to other active metals, such as sodium, potassium, calcium, and magnesium. In this connection, as used herein and in the appended claims, the letter “M” is used to denote both an active metal, such as lithium, sodium, potassium, calcium, or magnesium, among others, and a number of cations of the corresponding active metal in any particular instantiation of an electrolyte of the present disclosure, with the appropriate meaning being apparent from the context in which “M” is used. Similarly, the letter “O” is used herein and in the appended claims to denote both the element oxygen and a number of oxygen atoms, such as the number of oxygen atoms in a particular instantiation of any particular instantiation of a nonfluorinated hybrid-ether cosolvent system of the present disclosure, with the appropriate meaning being apparent from the context in which “O” is used.

It is noted that throughout the present disclosure and the appended claims, the term “about” when used with a corresponding numeric value refers to ±20% of the numeric value, typically ±10% of the numeric value, often ±5% of the numeric value, and most often ±2% of the numeric value. In some embodiments, the term “about” can mean the numeric value itself.

Examples with Lithium as the Active Metal

A lithium ion has a solvation number, SN, (a/k/a “coordination number”) of about 4, meaning that each lithium ion coordinates, on average, with about four solvent molecules more strongly than the solvent molecules bond with one another. In the context of nonfluorinated ether-based solvents, both cyclic and linear, the lithium ions bond with oxygen atoms in the solvent molecules. Consequently, in some embodiments, to minimize the amount of free, or nonsolvated, solvent molecules of the nonfluorinated hybrid-ether cosolvent system, the lithium-to-oxygen molar ratio, or Li:O molar ratio, should be in a range of about 1:1 to about 1:7, about 1:2 to about 1:5, about 1:2 to about 1:6, about 1:3.5 to about 1:4.5, or about 1:4, among others. Thus, in some embodiments, an electrolyte of the present disclosure may contain at least one cyclic ether, at least one linear ether, and at least one lithium-based salt, wherein the Li:O molar ratio as between the Li atoms of the salt(s) and the oxygen atoms of the nonfluorinated hybrid-ether system is in a range of about 1:1 to about 1:7, about 1:2 to about 1:5, about 1:2 to about 1:6, about 1:3 to about 1:5, about 1:3.5 to about 1:4.5, or about 1:4, among others. It should be appreciated that an alternative expression of Li:linear-solvent-molecule molar ratio can also be used. For example, if the linear solvent is ether (one oxygen per molecule), then the Li:linear-solvent-molecule molar ratio is 1:4 for 4 as the solvation number. However, if the linear solvent is diether (two oxygens per molecule), then the Li:linear-solvent-molecule molar ratio is 1:2 for 4 as the solvation number.

More generally, the active-metal-to-oxygen molar ratio, or M:O molar ratio, for an active metal M other than Li⁺ can be adjusted for differing solvation numbers SNs of the other active metal at issue. For example, in some embodiments, the desired/design M:O molar ratio may be generalized to fall within a range of about 1:(SN−3) to about 1:(SN+3), about 1:(SN−2) to about 1:(SN+2), about 1:(SN−1) to about 1:(SN+1), about 1:(SN−0.5) to about 1:(SN+0.5), or about 1:SN. Examples of other active metals M include, but are not limited to, sodium (Na⁺), which has an SN of about 5.7-5.8, and potassium (K⁺), which has a solvation number of about 6.9-7.0. When more than one nonfluorinated linear ethers having differing numbers of oxygen atoms are mixed with one another, the determination of the desired ratio becomes a bit more complex. For example, an example way to generalize is as follows for lithium (SN=4). The total moles of Li⁺ to the total moles of ether function group (=the mole number of oxygen) will equal to 1:4. If an ether solvent contains only one oxygen, it considered 1 mole, if the ether solvent contains two oxygen ether group, it considered 2 moles, etc. Thus the following equation can be established: [Li⁺ mole]/([1×mono-ether mole+2×diether mole+3×triether mole+4×tetraether mole+etc.]=4 (+/−any acceptable tolerance, if any, such as the +/−3, +/−2, +/−1, +/−0.5 examples noted above). The volume, weight, or mole ratio between the nonfluorinated cyclic ether(s) and the nonfluorinated linear ether(s) in the nonfluorinated hybrid-ether cosolvent system can be in a range of about 10:90 to about 90:10, about 30:70 to about 70:30, about 10:90 to about 40:60, or about 10:90 to about 25:75, among others.

When one or more fluorinated ethers are provided to an electrolyte of the present disclosure, such as the lithium-based electrolytes described in the immediately preceding paragraph, in some embodiments the fluorinated ether(s) can take a volume % of the final hybrid-ether electrolyte, i.e., the total volume of the lithium-based salt(s)+the nonfluorinated hybrid-ether cosolvent system+the fluorinated ether(s), in a range of about 5% to about 50% or in a range of about 25% to about 45%, among others. Within this, in some embodiments the volumetric ratio of the nonfluorinated hybrid-ether cosolvent system to fluorinated ether solvent may be in a range of about 70:30 to about 40:60, or about 65:35 to about 55:45, among others. In some embodiments, the final salt concentration (i.e., salt moles/L of the total solvents, including the nonfluorinated linear ether(s), the nonfluorinated cyclic ether(s), and the fluorinated ether(s), if present) may range from about 0.2M up to about 7M, from about 1.9M to about 4.5M, or about 2.0M to about 3.0M, among others. In some embodiments, the concentration of the salt(s) may be about 2 moles/L to about 5 moles/L of the nonfluorinated hybrid-ether cosolvent or about 3.5 moles/L to about 4.5 moles/L of the nonfluorinated hybrid-ether cosolvent system, among others.

Turning now to some specific examples, experiments have been conducted using electrolytes made in accordance with the present disclosure composed of LiFSI as a salt, 1,4-DX+DEE as a nonfluorinated hybrid-ether cosolvent system, and TFE as a fluorinated ether in attempt to maximize multiple functions from each of these components. For example, the 1,4-DX maintains its many merits listed above in the new electrolytes, while the DEE enables sufficient lithium salt solubility inside the entire electrolyte to reduce/eliminate uncoordinated free cyclic and linear ether solvents, and the TFE as diluent solvent has extremely low solubility towards LiFSI salt and decreases total viscosity of the new electrolytes.

The new coordination mechanism of a nonfluorinated hybrid-ether cosolvent system of this disclosure can play a very important role in the significant improvement of cycling stability of lithium batteries. In some embodiments, the optimal molar Li:O ratio is 1:4 (based on the solvation number of ˜4 for lithium as noted above) or the molar ratio of lithium cations to solvent molecules in the nonfluorinated hybrid-ether cosolvent system is 1:2 (with 2 oxygen atoms per nonfluorinated ether solvent molecule), each of which enables almost no free solvents to improve stability of electrolytes on anode and cathode. This considerable synergistic effect greatly drives significant improvements in anodic and cathodic stability of the new hybrid electrolyte of the present disclosure in lithium metal batteries, which has been well proven in testing of practical pouch cells, as discussed below.

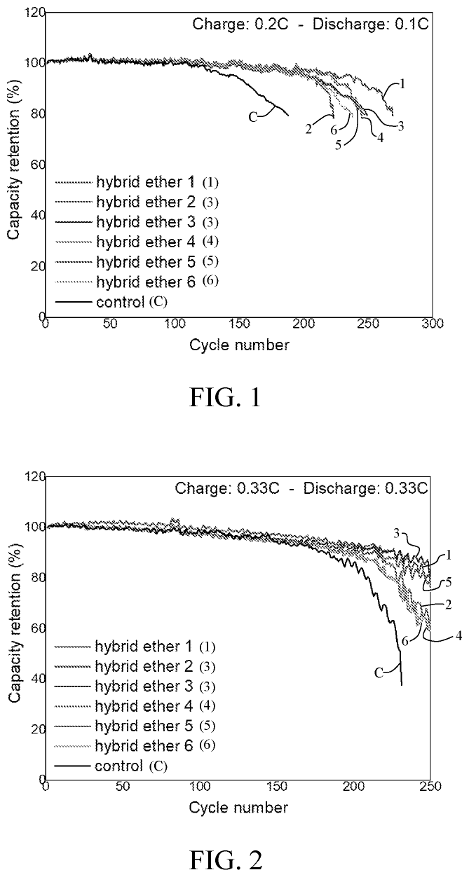

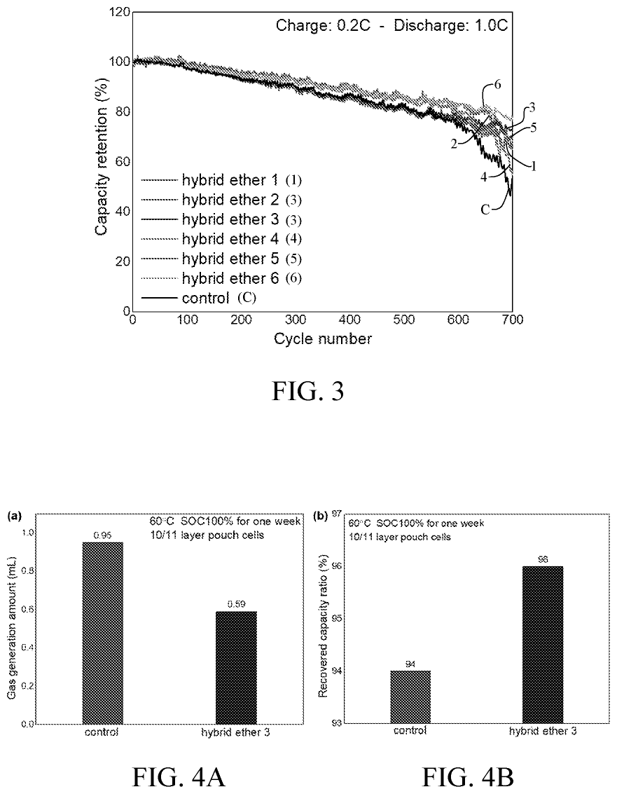

Compared to a control electrolyte in which the only nonfluorinated ether was a linear ether (3.6M LiFSI-DEE diluted by 40% volume TFE), pouch cells utilizing the newly invented 1,4-DX-based hybrid-ether electrolytes (e.g., “hybrid ether 1” through “hybrid ether 6” with formulation details listed in Table 1, below) clearly demonstrated much better cycling performance at various cycling conditions (0.2C-0.1C in FIG. 1, 0.33C-0.33C in FIG. 2, and 0.2C-1.0C in FIG. 3). The best tested hybrid-ether electrolyte formulations (here, hybrid ether 1, hybrid ether 3, and hybrid ether 6) of these example formulations delivered 43%, 20%, and 23% of cyclic life improvement when compared to the control electrolyte of the tests FIG. 1, FIG. 2, and FIG. 3, respectively.

TABLE 1

| | | | | | | | Volumetric |
|---|---|---|---|---|---|---|---|
| | | | | | | | ratio of non- |
| | | | | Molar ratio of | | Fluori- | fluorinated |
| | | | Molar ratio of | lithium:oxygen | Volumetric | nated | ether solvent |
| | Salt | Nonfluori- | salt:cyclic | atoms in | ratio of | ether - | (cyclic ether + |
| | concentration | nated | ether | non- | cyclic ether | TFE | linear |
| | before | hybrid | solvent:linear | fluorinated | solvent:linear | diluent | ether):fluori- |
| Electrolyte | dilution | cosolvent | ether | ether | ether | volume | nated ether |
| code | (M) | system | solvent | solvents | solvent | amount (%) | solvent |
| hybrid ether 1 | 4.09 | 1,4-DX:DEE | 1.45:0.9:2.0 | 1:4 | 21.7:78.3 | 30 | 65.4%:34.6% |
| hybrid ether 2 | 4.09 | 1,4-DX:DEE | 1.45:0.9:2.0 | 1:4 | 21.7:78.3 | 40 | 54.8%:45.2% |
| hybrid ether 3 | 3.97 | 1,4-DX:DEE | 1.45:0.7:2.2 | 1:4 | 16.3:83.7 | 30 | 65.5%:34.5% |
| hybrid ether 4 | 3.97 | 1,4-DX:DEE | 1.45:0.7:2.2 | 1:4 | 16.3:83.7 | 40 | 55%:45% |
| hybrid ether 5 | 3.86 | 1,4-DX:DEE | 1.45:0.5:2.4 | 1:4 | 11.3:88.7 | 30 | 65.6%:34.4% |
| hybrid ether 6 | 3.86 | 1,4-DX:DEE | 1.45:0.5:2.4 | 1:4 | 11.3:88.7 | 40 | 55.1%:44.9% |
| hybrid ether 7 | 3.86 | 1,3-DX:DEE | 1.45:0.5:2.4 | 1:4 | 11.3:88.7 | 40 | 55.1%:44.9% |

In addition, from safety point view, the hybrid ether 3 electrolyte, for example, also demonstrated less gas generation and a higher recovered capacity ratio than the control electrolyte upon high temperature storage at 100% state of charge (SOC), as shown in FIGS. 4A and 4B.

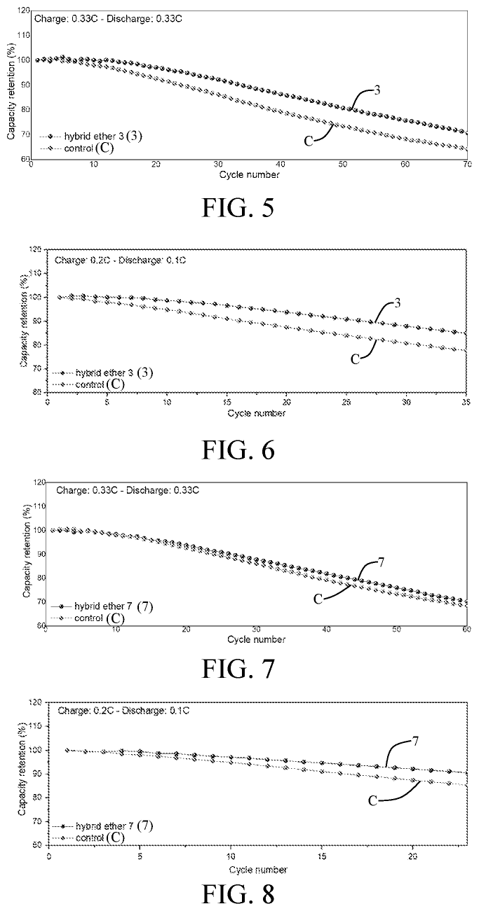

The cycling performance was further validated in anode-free Cu-NMC (copper-nickel-magnesium-cobalt) pouch cells containing the hybrid ether 3 electrolyte or the control electrolyte. This further testing has clearly revealed that these cells with advanced hybrid-ether electrolyte of the present disclosure (hybrid ether 3, in this example) is superior than the cells containing the control electrolyte under both 0.33C-0.33C cycling conditions (FIG. 5) and 0.2C-0.1C cycling conditions (FIG. 6), confirming the efficacy of the new hybrid-ether electrolytes that have higher CE of lithium plating/stripping.

To support the universal applicability of principles of this disclosure, the analogous cyclic solvent 1,3-dioxane (1,3-DX) was also tested. The corresponding cycling stabilities of anode-free pouch cells with 1,3-DX-based hybrid electrolyte (hybrid ether 7, with details about the example formulation in Table 1) and the control electrolyte as a comparison are provided in FIG. 7 and FIG. 8. The comparison illustrates that hybrid-ether electrolyte of the present disclosure exhibits higher cycling stability especially against lithium metal when compared to the linear-ether-only containing control electrolyte. On the basis of the above comprehensive results, the disclosed hybrid-ether electrolytes with very stable nonfluorinated cyclic ether solvent and a full salt-nonfluorinated solvent coordination network are able to promote superior battery cycling performance over previous control electrolyte.

Those skilled in the art will appreciate that the novel coordination scheme of hybrid-ether electrolytes of the present disclosure, namely tailoring the molar ratio of the salt cations to either the oxygen atoms of the nonfluorinated hybrid-ether cosolvent system or the solvent molecules in the nonfluorinated hybrid-ether cosolvent system, are applicable to a wide variety of salts, nonfluorinated cyclic ethers, nonfluorinated linear ethers, and fluorinated ethers (if included). For example, one or more of the following salts can be used: MFSI, MTFSI, MClO₄, MBF₄, MPF₆, MAsF₆, MTf, MBETI, MCTFSI, MTDI, MPDI, MDCTA, MB(CN)₄, MBOB, and MDFOB (M: Li, Na, K), among others, either single salt or multiple salts hybrid.

Examples of nonfluorinated cyclic ethers other than 1,4-DX and 1,3-DX discussed above include, but are not limited to, tetrahydropyran, tetrahydrofuran, 1,3-dioxolane, 2,4-dimethyltetrahydrofuran, 3,4-dimethyltetrahydrofuran, 2,5-dimethyltetrahydrofuran, 2,2-dimethyltetrahydrofuran, 3,3-dimethyltetrahydrofuran, 2-methyltetrahydrofuran, 3-methyltetrahydrofuran, and 2-ethyl-5-methyltetrahydrofuran, among others, singly or in any suitable combination. Those skilled in the art will readily understand that these examples of nonfluorinated cyclic ethers are presented for illustration and not completeness, as the usefulness of a compound as a nonfluorinated cyclic-ether solvent in the context of the present disclosure will depend on the ability of the compound to coordinate with salt cations to achieve the desired effects disclosed herein. Those skilled in the art will be readily able to discern useful nonfluorinated cyclic-ether solvents from non-useful ones by performing only routine experimentation.

Suitable nonfluorinated linear-ethers can contain molecules each having any number of oxygen atoms. For example: suitable one-oxygen-atom nonfluorinated linear ethers include, but are not limited to, methyl propyl ether, methyl butyl ether, ethyl propyl ether, ethyl butyl ether, propyl butyl ether, diethyl ether, dipropyl ether, and dibutyl ether, among others; suitable two-oxygen-atom nonfluorinated linear ethers other than DEE discussed above include, but are not limited to, 1,2-dimethoxy ethane, 1,2-dipropoxy ethane, and 1,2-dibutoxy ethane, among others; suitable three-oxygen-atom nonfluorinated linear ethers include, but are not limited to, bis(2-methoxyethyl) ether and 2-ethoxyethyl ether, among others; and suitable four-oxygen-atom nonfluorinated linear ethers include, but are not limited to, bis[2-(2-methoxyethoxy)ethyl] ether, among others. Those skilled in the art will readily understand that these examples of nonfluorinated linear ethers are presented for illustration and not completeness, as the usefulness of a compound as a nonfluorinated linear-ether solvent in the context of the present disclosure will depend on the ability of the compound to coordinate with salt cations to achieve the desired effects disclosed herein. Those skilled in the art will be readily able to discern useful nonfluorinated linear-ether solvents from non-useful ones by performing only routine experimentation.

Examples of fluorinated ethers other than TFE discussed above include, but are not limited to, CHF₂CF₂OCH₂CF₂CHF₂, CHF₂CF₂CH₂OCF₂CHFCF₃, CHF₂CF₂OCH₂CF₂CF₂CF₂CHF₂, CHF₂CF₂OCH(CH₃)₂, CF₃CH₂OCF₂CH(CH₃)CF₃, CH₃OCF₂CF₂OCH₃, CF₃CH₂OCH₂CH₂OCH₂CF₃, CF₃CHFOCH₂CH₂OCHFCF, CHF₂CF₂OCH₂CH₃, CHF₂CF₂OCH₂CF₃, and CF₃CH₂OCH₂CF₃, among others. Those skilled in the art will readily understand that these examples of fluorinated ethers are presented for illustration and not completeness, as the usefulness of a compound as a fluorinated ether in the context of the present disclosure will depend on the ability of the compound to achieve the desired effect(s) disclosed herein, such as dilution and participation in SEI formation, among others. Those skilled in the art will be readily able to discern useful fluorinated ethers from non-useful ones by performing only routine experimentation.

As noted above, a hybrid ether electrolyte of the present disclosure may, optionally, also contain one or more other types of solvents, such as carbonates, sulfonates, phosphates, either nonfluorinated or fluorinated. In some embodiments, when such other solvent(s) is/are present, the amount of other solvent(s) should be present in an amount of 5% or less, by volume, of the volume of the final electrolyte.

The present disclosure may also be considered to describe a method of preparing a hybrid-ether electrolyte for an electrochemical device, such as a secondary cell having active-metal anodes that experience plating/stripping of an active metal during charging/discharging. The method includes selecting one or more salts for providing salt cations compatible with the chemistry of the electrochemical device. Using a lithium-based chemistry as an example, the method includes selecting one or more lithium-based salts, such as one or more of the lithium-based salts noted above.

The method also includes creating a nonfluorinated hybrid-ether cosolvent system containing at least one nonfluorinated cyclic ether and at least one nonfluorinated linear ether. In some embodiments, each nonfluorinated cyclic and linear ether may be selected from among the example nonfluorinated cyclic and linear ethers listed above or otherwise disclosed herein. The selection of the nonfluorinated cyclic and linear ethers may be based on a number of factors, including, but not limited to the ability to solvate the selected salt(s), the boiling point(s), the viscosity(ies), oxidative stability at high voltage, reduction potential with Li, chemical stability towards lithium metal, and gassing generation, among others. Those skilled in the art will readily understand the factors that need to be considered, outside of the salt cation coordination ability disclosed herein, when selecting suitable nonfluorinated cyclic and linear ethers. It is noted that the nonfluorinated hybrid-ether cosolvent system may be created at any time in the overall method, such as before mixing with the salt(s), or after one of the nonfluorinated ether types (cyclic and linear) has already been mixed with the salt(s), among others. In the latter example, the nonfluorinated hybrid-ether cosolvent system is created once all of the nonfluorinated cyclic and linear ethers have been provided to the hybrid-ether electrolyte.

The method further includes combining the salt(s) and the nonfluorinated hybrid-ether cosolvent system in proportions so that the molar ratio of M:O or M:(solvent molecules in the nonfluorinated hybrid-ether cosolvent system) is such that the number of free solvent molecules from the nonfluorinated hybrid-ether cosolvent system is minimized. As discussed above, this step may include utilizing the solvation number, SN, of the salt cations, M, at issue and either the number of oxygen atoms, O, in each solvent molecule of the nonfluorinated hybrid-ether cosolvent system to determine a corresponding molar ratio that may then be used to formulate the appropriate proportions of the salt(s) and nonfluorinated hybrid-ether cosolvent system to mix with one another to achieve the desired minimized-free-solvent hybrid-ether electrolyte and a desired salt concentration. In some embodiments, other characteristics of the hybrid-ether electrolyte may need to be considered in conjunction with minimizing the amount of free solvent using the disclosed techniques. For example, it may be desired to maintain the viscosity of the hybrid-ether electrolyte as low as possible, while also keeping the electrolyte conductivity as high as possible, all while trying to balance all of the parameters under a condition that the electrochemical stability window is compatible with the overall cell chemistry. Consequently, and as those skilled in the art will appreciate, an appropriate formulation of a hybrid-ether electrolyte of the present disclosure—although designed in accordance with the general principles disclosed herein—may not have the exact M:O molar ratio for the relevant solvation number at issue. Indeed, this is a reason why desirable M:O molar ratios in various instantiations may have values within the example ranges noted above.

The method may optionally include adding one or more fluorinated ethers to the hybrid-ether electrolyte. Each fluorinated ether may be selected, for example, from among the fluorinated ethers mentioned above. The amount of fluorinated ether(s) added may be an amount selected based on one or more criteria, such as an amount needed to obtain a desired/design overall salt concentration (i.e., relative to the total amounts of the nonfluorinated cyclic and linear ethers and the fluorinated ether(s)), an amount needed to achieve a desired overall viscosity of the hybrid-ether electrolyte, and an amount sufficient for participating in SEI formation, among others, and any combination thereof.

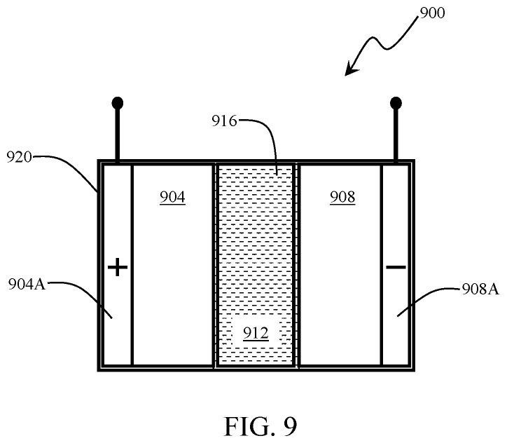

FIG. 9 illustrates a highly simplified electrochemical device 900 made in accordance with aspects of the present disclosure. Those skilled in the art will readily appreciate that the electrochemical device 900 can be, for example, a battery cell or a supercapacitor. In addition, those skilled in the art will readily understand that FIG. 9 illustrates only some basic functional components of the electrochemical device 900 and that a real-world instantiation of the electrochemical device, such as a secondary battery cell or a supercapacitor, will typically be embodied using either a wound construction or a stacked construction composed of one or more of the various layers depicted in FIG. 9. Further, those skilled in the art will understand that the electrochemical device 900 may include other components, such as electrical leads, electrical terminals, seal(s), thermal shutdown layer(s), electrical circuitry, gas-gettering feature(s), and/or vent(s), among other things, that, for ease of illustration, are not shown in FIG. 9.

In this example, the electrochemical device 900 includes spaced-apart cathode 904 and anode 908 and a pair of corresponding respective current collectors 904A, 908A. A porous dielectric separator 912 is located between the cathode 904 and the anode 908 to electrically separate them from one another but to allow ions within a hybrid-ether electrolyte 916 made in accordance with the present disclosure to flow therethrough. The porous dielectric separator 912 and/or one, the other, or both of the cathode 904 and the anode 908, depending on whether porous or not, is/are impregnated at least partially with the hybrid-ether electrolyte 916. The electrochemical device 900 includes a sealed container 920 that contains at least the cathode 904, the anode 908, the porous dielectric separator 912, and the hybrid-ether electrolyte 916.

As those skilled in the art will understand, depending upon the type and design of the electrochemical device 900, each of the cathode 904 and the anode 908 comprises a suitable material compatible with the salt ions and other constituents of the hybrid-ether electrolyte 916. In some embodiments, the anode 908 may be an active-metal anode that functions by plating/stripping of an active metal (e.g., lithium or any of the others noted above) during charging/discharging. Each of the current collectors 904A, 908A may be made of any suitable electrically conducting material. The porous dielectric separator 912 may be made of any suitable porous dielectric material, such as a porous polymer, a ceramic-coated porous polymer, among others. Many battery and supercapacitor constructions that can be used for constructing the electrochemical device 900 of FIG. 9, are known in the art, such that it is not necessary to describe them in any detail for those skilled in the art to understand how to make and use the various aspects of the present disclosure to their fullest scope.

As those skilled in the art will readily appreciate, the presence of the hybrid-ether electrolyte 916, which is made in accordance with this disclosure provides novelty to the electrochemical device 900. The hybrid-ether electrolyte 916 may be any formulation disclosed herein by way of examples, method of formulation, and/or underlying fundamental principles.

In some aspects, the present disclosure is directed to a method of preparing a hybrid-ether electrolyte for an electrochemical cell that operates using an active metal. The method includes selecting one or more salts for providing cations of the active metal; selecting at least one nonfluorinated cyclic ether and at least one nonfluorinated linear ether to participate in a nonfluorinated hybrid-ether cosolvent system; combining the one or more salts, the one or more nonfluorinated cyclic ether, and the one or more nonfluorinated linear ether with one another so that the hybrid-ether electrolyte has an M:O molar ratio in a range of about 1:(SN−3) to about 1:(SN+3), wherein M is a total number of cations of the active metal in the one or more salts, O is the total number of oxygen atoms in the nonfluorinated hybrid-ether cosolvent system, and SN is the solvation number of the active metal.

In one or more embodiments of the method, wherein the M:O molar ratio is in a range of about 1:(SN−2) to about 1:(SN+2).

In one or more embodiments of the method, wherein the M:O molar ratio is in a range of about 1:(SN−0.5) to about 1:(SN+0.5).

In one or more embodiments of the method, wherein the M:O molar ratio is about 1:SN.

In one or more embodiments of the method, wherein the active metal is lithium, and the M:O molar ratio is in a range of about 1:1 to about 1:7.

In one or more embodiments of the method, wherein the active metal is lithium, and the M:O molar ratio is in a range of about 1:2 to about 1:5.

In one or more embodiments of the method, wherein the active metal is lithium, and the M:O molar ratio is in a range of about 1:3.5 to about 1:4.5.

In one or more embodiments of the method, wherein the active metal is lithium, and the M:O molar ratio is about 1:4.

In one or more embodiments of the method, wherein the hybrid-ether electrolyte has a total salt to nonfluorinated hybrid-ether cosolvent system concentration in a range of about 3.5 moles/L to about 5 moles/L.

In one or more embodiments of the method, wherein the hybrid-ether electrolyte has a total salt to nonfluorinated hybrid-ether cosolvent system concentration in a range of about 3.5 moles/L to about 4.5 moles/L.

In one or more embodiments of the method, wherein the active metal is lithium.

In one or more embodiments of the method, further comprising one or more fluorinated ethers.

In one or more embodiments of the method, wherein the hybrid-ether electrolyte has a volumetric ratio for the nonfluorinated hybrid-ether cosolvent system to the one or more fluorinated ethers is in a range of about 70:30 to about 40:60.

In one or more embodiments of the method, wherein the hybrid-ether electrolyte has a volumetric ratio for the nonfluorinated hybrid-ether cosolvent system to the one or more fluorinated ethers is in a range of about 65:35 to about 55:45.

In one or more embodiments of the method, wherein the active-metal is lithium, and at least one nonfluorinated cyclic ether is selected from the group consisting of 1,4-dioxane, 1,3-dioxane, tetrahydropyran, tetrahydrofuran, 1,3-dioxolane, 2,4-dimethyltetrahydrofuran, 3,4-dimethyltetrahydrofuran, 2,5-dimethyltetrahydrofuran, 2,2-dimethyltetrahydrofuran, 3,3-dimethyltetrahydrofuran, 2-methyltetrahydrofuran, 3-methyltetrahydrofuran, and 2-ethyl-5-methyltetrahydrofuran.

In one or more embodiments of the method, wherein the active-metal is lithium, and at least one nonfluorinated linear ether is selected from the group consisting of methyl propyl ether, methyl butyl ether, ethyl propyl ether, ethyl butyl ether, propyl butyl ether, diethyl ether, dipropyl ether, dibutyl ether, 1,2-diethoxy ethane, 1,2-dimethoxy ethane, 1,2-dipropoxy ethane, and 1,2-dibutoxy ethane, bis(2-methoxyethyl) ether and 2-ethoxyethyl ether, and bis[2-(2-methoxyethoxy)ethyl] ether.

In one or more embodiments of the method, wherein the active-metal is lithium, and at least one fluorinated ether is selected from the group consisting of CHF2CF2OCH2 CH2OCF2CHF2, CHF2CF2OCH2CF2CHF2, CHF2CF2CH2OCF2CHFCF3, CHF2CF2OCH2CF2CF2CF2CHF2, CHF2CF2OCH(CH3)2, CF3CH2OCF2CH(CH3)CF3, CH3OCF2CF2OCH3, CF3CH2OCH2CH2OCH2CF3, CF3CHFOCH2CH2OCHFCF, CHF2CF2OCH2CH3, CHF2CF2OCH2CF3, and CF3CH2OCH2CF3.

In one or more embodiments of the method, wherein the active-metal is lithium, and at least one fluorinated ether is selected from the group consisting of CHF2CF2OCH2 CH2OCF2CHF2, CHF2CF2OCH2CF2CHF2, CHF2CF2CH2OCF2CHFCF3, CHF2CF2OCH2CF2CF2CF2CHF2, CHF2CF2OCH(CH3)2, CF3CH2OCF2CH(CH3)CF3, CH3OCF2CF2OCH3, CF3CH2OCH2CH2OCH2CF3, CF3CHFOCH2CH2OCHFCF, CHF2CF2OCH2CH3, CHF2CF2OCH2CF3, and CF3CH2OCH2CF3.

In one or more embodiments of the method, wherein the at least one salt is selected from the group consisting of LiFSI, LiTFSI, LiClO4, LiBF4, LiPF6, LiAsF6, LiTf, LiBETI, LiCTFSI, LiTDI, LiPDI, LiDCTA, LiB(CN)4, LiBOB, and LiDFOB.

In one or more embodiments of the method, wherein the at least one salt is selected from the group consisting of LiFSI, LiTFSI, LiClO4, LiBF4, LiPF6, LiAsF6, LiTf, LiBETI, LiCTFSI, LiTDI, LiPDI, LiDCTA, LiB(CN)4, LiBOB, and LiDFOB.

In one or more embodiments of the method, wherein the at least one salt is a lithium-based salt; the at least one nonfluorinated cyclic ether comprises either 1,4-dioxane, 1,3-dioxane, or both; and the at least one nonfluorinated linear ether comprises 1,2-diethoxy ethane (DEE).

In one or more embodiments of the method, wherein the at least one salt is LiFSI.

In one or more embodiments of the method, wherein the at least one nonfluorinated ether is 1,4 dioxane.

In one or more embodiments of the method, wherein the at least one nonfluorinated ether is 1,3 dioxane.

In one or more embodiments of the method, further comprising 1,2-(1,1,2,2-tetrafluoroethoxy) ethane (TFE).

In one or more embodiments of the method, wherein the M:O molar ratio is about 1:4.

In one or more embodiments of the method, wherein the hybrid-ether electrolyte has a volumetric ratio for the nonfluorinated hybrid-ether cosolvent system to the TFE is in a range of about 65:35 to about 55:45.

In one or more embodiments of the method, wherein the nonfluorinated hybrid-ether cosolvent system has a volumetric ratio of the at least one nonfluorinated cyclic ether to the at least one nonfluorinated linear ether is in a range of about 10:90 to about 25:75.

In one or more embodiments of the method, wherein the hybrid-ether electrolyte further comprises at least one additional solvent selected from the group consisting of carbonates, sulfonates, and phosphates, each of which may be either fluorinated or nonfluorinated.

In one or more embodiments of the method, wherein all of the at least one additional solvent have a combined volume that composes about 5% or less than a total volume of the hybrid-ether electrolyte.

In one or more embodiments of the method, further comprising performing calculations for determining amounts of the one or more salts and the one or more nonfluorinated linear ether, wherein the calculations include a target range for the M:O molar ratio.

In some aspects, the present disclosure is directed to an electrochemical cell, which includes an anode comprising an active metal at least when the electrochemical cell is in a charged state; a cathode; a separator electrically separating the anode and cathode from one another; and a hybrid-ether electrolyte ionically coupling the anode and the cathode with one another so as to conduct ions of the active metal between the anode and the cathode during charging and discharging of the electrochemical cell, wherein the hybrid-ether electrolyte comprises: at least one salt comprising a total number of cations, M, of an active metal, wherein the active metal has a solvation number, SN; and a nonfluorinated hybrid-ether cosolvent system that consists of at least one nonfluorinated cyclic ether and at least one nonfluorinated linear ether, wherein the nonfluorinated hybrid-ether cosolvent system has a total number of oxygen atoms, O; and wherein the at least one salt and the nonfluorinated hybrid-ether cosolvent system are present in respective amounts such that the hybrid-ether electrolyte has an M:O molar ratio in a range of about 1:(SN−3) to about 1:(SN+3).

In one or more embodiments of the electrochemical cell, wherein the M:O molar ratio is in a range of about 1:(SN−2) to about 1:(SN+2).

In one or more embodiments of the electrochemical cell, wherein the M:O molar ratio is in a range of about 1:(SN−0.5) to about 1:(SN+0.5).

In one or more embodiments of the electrochemical cell, wherein the M:O molar ratio is about 1:SN.

In one or more embodiments of the electrochemical cell, wherein the active metal is lithium, and the M:O molar ratio is in a range of about 1:1 to about 1:7.

In one or more embodiments of the electrochemical cell, wherein the active metal is lithium, and the M:O molar ratio is in a range of about 1:2 to about 1:5.

In one or more embodiments of the electrochemical cell, wherein the active metal is lithium, and the M:O molar ratio is in a range of about 1:3.5 to about 1:4.5.

In one or more embodiments of the electrochemical cell, wherein the active metal is lithium, and the M:O molar ratio is about 1:4.

In one or more embodiments of the electrochemical cell, wherein the hybrid-ether electrolyte has a total salt to nonfluorinated hybrid-ether cosolvent system concentration in a range of about 3.5 moles/L to about 5 moles/L.

In one or more embodiments of the electrochemical cell, wherein the hybrid-ether electrolyte has a total salt to nonfluorinated hybrid-ether cosolvent system concentration in a range of about 3.5 moles/L to about 4.5 moles/L.

In one or more embodiments of the electrochemical cell, wherein the active metal is lithium.

In one or more embodiments of the electrochemical cell, further comprising one or more fluorinated ethers.

In one or more embodiments of the electrochemical cell, wherein the hybrid-ether electrolyte has a volumetric ratio for the nonfluorinated hybrid-ether cosolvent system to the one or more fluorinated ethers is in a range of about 70:30 to about 40:60.

In one or more embodiments of the electrochemical cell, wherein the hybrid-ether electrolyte has a volumetric ratio for the nonfluorinated hybrid-ether cosolvent system to the one or more fluorinated ethers is in a range of about 65:35 to about 55:45.

In one or more embodiments of the electrochemical cell, wherein the anode is a lithium-metal anode, the active-metal is lithium, and at least one nonfluorinated cyclic ether is selected from the group consisting of 1,4-dioxane, 1,3-dioxane, tetrahydropyran, tetrahydrofuran, 1,3-dioxolane, 2,4-dimethyltetrahydrofuran, 3,4-dimethyltetrahydrofuran, 2,5-dimethyltetrahydrofuran, 2,2-dimethyltetrahydrofuran, 3,3-dimethyltetrahydrofuran, 2-methyltetrahydrofuran, 3-methyltetrahydrofuran, and 2-ethyl-5-methyltetrahydrofuran.

In one or more embodiments of the electrochemical cell, wherein the anode is a lithium-metal anode, the active-metal is lithium, and at least one nonfluorinated linear ether is selected from the group consisting of methyl propyl ether, methyl butyl ether, ethyl propyl ether, ethyl butyl ether, propyl butyl ether, diethyl ether, dipropyl ether, dibutyl ether, 1,2-diethoxy ethane, 1,2-dimethoxy ethane, 1,2-dipropoxy ethane, and 1,2-dibutoxy ethane, bis(2-methoxyethyl) ether and 2-ethoxyethyl ether, and bis[2-(2-methoxyethoxy)ethyl] ether, made using any one of the electrochemical cells recited herein.

In one or more embodiments of the electrochemical cell, wherein the anode is a lithium-metal anode, the active-metal is lithium, and at least one fluorinated ether is selected from the group consisting of CHF2CF2OCH2 CH2OCF2CHF2, CHF2CF2OCH2CF2CHF2, CHF2CF2CH2OCF2CHFCF3, CHF2CF2OCH2CF2CF2CF2CHF2, CHF2CF2OCH(CH3)2, CF3CH2OCF2CH(CH3)CF3, CH3OCF2CF2OCH3, CF3CH2OCH2CH2OCH2CF3, CF3CHFOCH2CH2OCHFCF, CHF2CF2OCH2CH3, CHF2CF2OCH2CF3, and CF3CH2OCH2CF3.

In one or more embodiments of the electrochemical cell, wherein the anode is a lithium-metal anode, the active-metal is lithium, and at least one fluorinated ether is selected from the group consisting of CHF2CF2OCH2 CH2OCF2CHF2, CHF2CF2OCH2CF2CHF2, CHF2CF2CH2OCF2CHFCF3, CHF2CF2OCH2CF2CF2CF2CHF2, CHF2CF2OCH(CH3)2, CF3CH2OCF2CH(CH3)CF3, CH3OCF2CF2OCH3, CF3CH2OCH2CH2OCH2CF3, CF3CHFOCH2CH2OCHFCF, CHF2CF2OCH2CH3, CHF2CF2OCH2CF3, and CF3CH2OCH2CF3.

In one or more embodiments of the electrochemical cell, wherein the at least one salt is selected from the group consisting of LiFSI, LiTFSI, LiClO4, LiBF4, LiPF6, LiAsF6, LiTf, LiBETI, LiCTFSI, LiTDI, LiPDI, LiDCTA, LiB(CN)4, LiBOB, and LiDFOB.

In one or more embodiments of the electrochemical cell, wherein the at least one salt is selected from the group consisting of LiFSI, LiTFSI, LiClO4, LiBF4, LiPF6, LiAsF6, LiTf, LiBETI, LiCTFSI, LiTDI, LiPDI, LiDCTA, LiB(CN)4, LiBOB, and LiDFOB, made using any one of the electrochemical cells recited herein.

In one or more embodiments of the electrochemical cell, wherein the at least one salt is a lithium-based salt; the at least one nonfluorinated cyclic ether comprises either 1,4-dioxane, 1,3-dioxane, or both; and the at least one nonfluorinated linear ether comprises 1,2-diethoxy ethane (DEE).

In one or more embodiments of the electrochemical cell, wherein the at least one salt is LiFSI.

In one or more embodiments of the electrochemical cell, wherein the at least one nonfluorinated ether is 1,4 dioxane.

In one or more embodiments of the electrochemical cell, wherein the at least one nonfluorinated ether is 1,3 dioxane.

In one or more embodiments of the electrochemical cell, further comprising 1,2-(1,1,2,2-tetrafluoroethoxy) ethane (TFE).

In one or more embodiments of the electrochemical cell, wherein the M:O molar ratio is about 1:4.

In one or more embodiments of the electrochemical cell, wherein the hybrid-ether electrolyte has a volumetric ratio for the nonfluorinated hybrid-ether cosolvent system to the TFE is in a range of about 65:35 to about 55:45.

In one or more embodiments of the electrochemical cell, wherein the nonfluorinated hybrid-ether cosolvent system has a volumetric ratio of the at least one nonfluorinated cyclic ether to the at least one nonfluorinated linear ether is in a range of about 10:90 to about 25:75.

In one or more embodiments of the electrochemical cell, further comprising at least one additional solvent selected from the group consisting of carbonates, sulfonates, and phosphates, each of which may be either fluorinated or nonfluorinated.

In one or more embodiments of the electrochemical cell, wherein all of the at least one additional solvent have a combined volume that composes about 5% or less than a total volume of the hybrid-ether electrolyte.

Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve aspects of the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. A hybrid-ether electrolyte, comprising:
at least one salt comprising a total number of cations, M, of an active metal, wherein the active metal has a solvation number, SN; and
a nonfluorinated hybrid-ether cosolvent system that consists of at least one nonfluorinated cyclic ether and at least one nonfluorinated linear ether, wherein the nonfluorinated hybrid-ether cosolvent system has a total number of oxygen atoms, O; and
wherein the at least one salt and the nonfluorinated hybrid-ether cosolvent system are present in respective amounts such that the hybrid-ether electrolyte has an M:O molar ratio in a range of about 1:(SN−3) to about 1:(SN+3).

2. The hybrid-ether electrolyte of claim 1, wherein the M:O molar ratio is in a range of about 1:(SN−2) to about 1:(SN+2).

3. The hybrid-ether electrolyte of claim 1, wherein the M:O molar ratio is in a range of about 1:(SN−0.5) to about 1:(SN+0.5).

4. The hybrid-ether electrolyte of claim 1, wherein the M:O molar ratio is about 1:SN.

5. The hybrid-ether electrolyte of claim 1, wherein the active metal is lithium, and the M:O molar ratio is in a range of about 1:1 to about 1:7.

6. The hybrid-ether electrolyte of claim 1, wherein the active metal is lithium, and the M:O molar ratio is in a range of about 1:2 to about 1:5.

7. The hybrid-ether electrolyte of claim 1, wherein the active metal is lithium, and the M:O molar ratio is in a range of about 1:3.5 to about 1:4.5.

8. The hybrid-ether electrolyte of claim 1, wherein the active metal is lithium, and the M:O molar ratio is about 1:4.

9. The hybrid-ether electrolyte of claim 1, wherein the hybrid-ether electrolyte has a total salt to nonfluorinated hybrid-ether cosolvent system concentration in a range of about 3.5 moles/L to about 5 moles/L.

10. The hybrid-ether electrolyte of claim 1, wherein the hybrid-ether electrolyte has a total salt to nonfluorinated hybrid-ether cosolvent system concentration in a range of about 3.5 moles/L to about 4.5 moles/L.

11. The hybrid-ether electrolyte of claim 10, wherein the active metal is lithium.

12. The hybrid-ether electrolyte of claim 1, further comprising one or more fluorinated ethers.

13. The hybrid-ether electrolyte of claim 12, wherein the hybrid-ether electrolyte has a volumetric ratio for the nonfluorinated hybrid-ether cosolvent system to the one or more fluorinated ethers is in a range of about 70:30 to about 40:60.

14. The hybrid-ether electrolyte of claim 12, wherein the hybrid-ether electrolyte has a volumetric ratio for the nonfluorinated hybrid-ether cosolvent system to the one or more fluorinated ethers is in a range of about 65:35 to about 55:45.

15. The hybrid-ether electrolyte of claim 1, wherein the active-metal is lithium, and at least one nonfluorinated cyclic ether is selected from the group consisting of 1,4-dioxane, 1,3-dioxane, tetrahydropyran, tetrahydrofuran, 1,3-dioxolane, 2,4-dimethyltetrahydrofuran, 3,4-dimethyltetrahydrofuran, 2,5-dimethyltetrahydrofuran, 2,2-dimethyltetrahydrofuran, 3,3-dimethyltetrahydrofuran, 2-methyltetrahydrofuran, 3-methyltetrahydrofuran, and 2-ethyl-5-methyltetrahydrofuran.

16. The hybrid-ether electrolyte of claim 1, wherein the active-metal is lithium, and at least one nonfluorinated linear ether is selected from the group consisting of methyl propyl ether, methyl butyl ether, ethyl propyl ether, ethyl butyl ether, propyl butyl ether, diethyl ether, dipropyl ether, dibutyl ether, 1,2-diethoxy ethane, 1,2-dimethoxy ethane, 1,2-dipropoxy ethane, and 1,2-dibutoxy ethane, bis(2-methoxyethyl) ether and 2-ethoxyethyl ether, and bis[2-(2-methoxyethoxy)ethyl] ether.

17. The hybrid-ether electrolyte of claim 12, wherein the active-metal is lithium, and at least one fluorinated ether is selected from the group consisting of CHF₂CF₂OCH₂ CH₂OCF₂CHF₂, CHF₂CF₂OCH₂CF₂CHF₂, CHF₂CF₂CH₂OCF₂CHFCF₃, CHF₂CF₂OCH₂CF₂CF₂CF₂CHF₂, CHF₂CF₂OCH(CH₃)₂, CF₃CH₂OCF₂CH(CH₃)CF₃, CH₃OCF₂CF₂OCH₃, CF₃CH₂OCH₂CH₂OCH₂CF₃, CF₃CHFOCH₂CH₂OCHFCF, CHF₂CF₂OCH₂CH₃, CHF₂CF₂OCH₂CF₃, and CF₃CH₂OCH₂CF₃.

18. The hybrid-ether electrolyte of claim 1, wherein the active-metal is lithium, and at least one fluorinated ether is selected from the group consisting of CHF₂CF₂OCH₂ CH₂OCF₂CHF₂, CHF₂CF₂OCH₂CF₂CHF₂, CHF₂CF₂CH₂OCF₂CHFCF₃, CHF₂CF₂OCH₂CF₂CF₂CF₂CHF₂, CHF₂CF₂OCH(CH₃)₂, CF₃CH₂OCF₂CH(CH₃)CF₃, CH₃OCF₂CF₂OCH₃, CF₃CH₂OCH₂CH₂OCH₂CF₃, CF₃CHFOCH₂CH₂OCHFCF, CHF₂CF₂OCH₂CH₃, CHF₂CF₂OCH₂CF₃, and CF₃CH₂OCH₂CF₃.

19. The hybrid-ether electrolyte of claim 18, wherein the at least one salt is selected from the group consisting of LiFSI, LiTFSI, LiClO₄, LiBF₄, LiPF₆, LiAsF₆, LiTf, LiBETI, LiCTFSI, LiTDI, LiPDI, LiDCTA, LiB(CN)₄, LiBOB, and LiDFOB.

20. The hybrid-ether electrolyte of claim 1, wherein the at least one salt is selected from the group consisting of LiFSI, LiTFSI, LiClO₄, LiBF₄, LiPF₆, LiAsF₆, LiTf, LiBETI, LiCTFSI, LiTDI, LiPDI, LiDCTA, LiB(CN)₄, LiBOB, and LiDFOB.

21. The hybrid-ether electrolyte of claim 1, wherein:
the at least one salt is a lithium-based salt;
the at least one nonfluorinated cyclic ether comprises either 1,4-dioxane, 1,3-dioxane, or both; and
the at least one nonfluorinated linear ether comprises 1,2-diethoxy ethane (DEE).

22. The hybrid-ether electrolyte of claim 21, wherein the at least one salt is LiFSI.

23. The hybrid-ether electrolyte of claim 21, wherein the at least one nonfluorinated ether is 1,4 dioxane.

24. The hybrid-ether electrolyte of claim 21, wherein the at least one nonfluorinated ether is 1,3 dioxane.

25. The hybrid-ether electrolyte of claim 21, further comprising 1,2-(1,1,2,2-tetrafluoroethoxy) ethane (TFE).

26. The hybrid-ether electrolyte of claim 25, wherein the M:O molar ratio is about 1:4.

27. The hybrid-ether electrolyte of claim 25, wherein the hybrid-ether electrolyte has a volumetric ratio for the nonfluorinated hybrid-ether cosolvent system to the TFE is in a range of about 65:35 to about 55:45.

28. The hybrid-ether electrolyte of claim 25, wherein the nonfluorinated hybrid-ether cosolvent system has a volumetric ratio of the at least one nonfluorinated cyclic ether to the at least one nonfluorinated linear ether is in a range of about 10:90 to about 25:75.

29. The hybrid-ether electrolyte of claim 1, further comprising at least one additional solvent selected from the group consisting of carbonates, sulfonates, and phosphates, each of which may be either fluorinated or nonfluorinated.

30. The hybrid-ether electrolyte of claim 29, wherein all of the at least one additional solvent have a combined volume that composes about 5% or less than a total volume of the hybrid-ether electrolyte.
